(19) United States
(12) Patent Application Publication
(10) Pub. No.: US 2006/0114241 A1
(43) Pub. Date: Jun. 1, 2006

(54) Identification method for touch control device

(75) Inventor: Yi-Chan Lin, Taipei City (TW)

Correspondence Address: BEVER HOFFMAN & HARMS, LLP;TRI-VALLEY OFFICE, 1432 CONCANNON BLVD., BLDG. G, LIVERMORE, CA, 94550, US

(73) Assignee: Holtek Semiconductor Inc., Hsinchu (TW)

(21) Appl. No.: 11/148,577

(22) Filed: Jun. 8, 2005

(30) Foreign Application Priority Data
Nov. 29, 2004 (TW) 093136801

(51) Int. Cl. G09G 5/00

(52) U.S. Cl. 345/173

(57) ABSTRACT

An identification method for a touch control device having a memory and a pad electrically connected to an equivalent capacitance is provided. The provided identification method for a touch control device includes steps of: (a) charging the equivalent capacitance for obtaining a first voltage value; (b) storing the first voltage value in the memory; (c) touching the pad; (d) scanning the pad for obtaining a second voltage value of the equivalent capacitance; and (e) comparing the first voltage value with the second voltage of the equivalent capacitance for identifying a touched position on the pad.

### FIELD OF THE INVENTION

The present invention relates to an identification method for a touch control device, and more particular to an identification method for a capacitive touch control device.

### BACKGROUND OF THE INVENTION

Generally the systemic design for a touch control device is divided into two types: the capacitive touch control device and the resistive touch control device. Take a common capacitive touch control device for example, for identifying which key/pad position of the device is touched, firstly the electric potential energy charged for a specific key/pad position is recorded while the device is activated. The recorded electric potential is regarded as a no-touch electric potential. After the “touch” action is done, the device identifies whether the key/pad position is touched by comparing the electric potentials charged for each of the keys/pad positions with the no-touch electric potential. The key/pad position with a relative lower electric potential, which could be recorded as a voltage value, is recognized as being in a touch condition, otherwise the device takes no notice of that.

Take a further look at the action of an actual electronic element in the common capacitive touch control device. Firstly the capacitive touch control device generates a pulse series to the capacitive element of a specific key/pad position (or certain keys/pad positions) with an equivalent capacitance, and the energy of the pulse series is integrated and stored by an integrator, which is coupled to the capacitive element of the specific key or to the equivalent capacitance of the pad. The waveform of the integrated pulse series is amplified and then converted to a digital signal while the pulse series is transmitted. At last, the digital signal is stored in a memory and the stored value of the digital signal is read as a bias level. Afterward, each key/pad position within the touch control sensitive area is continuously scanned, and the integrated electric potential is amplified and converted to a respective digital signal. Finally, the touch control device could identify which key/pad position is touched by comparing the value of each digital signal with the previously recorded value of the bias level. While the digital signal value of a key/pad position is below the bias level, the key/pad position is identified as being in a touch condition. This conventional touch control device is advantageous for occupying little systemic memories.

However, if a touch control device with the need of having a large amount of keys/pad positions uses the above-mentioned identification method for determining whether or which key/pad position is touched, the sensitivity and the sensing capability of the touch control device would be seriously affected, since an error resulting from plural coupling capacitors or the equivalent capacitor thereof is generated. That is to say, the conventional identification method is suitable for a capacitive touch control device with a small amount of keys/pad positions, however while it is applied for the capacitive touch control device with a large amount of keys/pad positions, the sensitivity and the sensing area thereof are unable to be improved, since the energy stored in the equivalent capacitance for each key/pad position is not uniform distributed.

For overcoming the defects described above, many efforts have been made to improve the qualities of the coupling capacitors or the qualities of the equivalent capacitance of the pad. Nevertheless, now the following two troublesome problems are still hard to be solved.

Firstly, although the capacitance of each capacitor is labeled identically, actually it is different from each other due to the producing inaccuracy in the fabrication. Hence the electric potentials charged thereby in the condition of a constant current and a constant time interval are different. It needs to measure an initial capacitance of each capacitor first while applying the conventional identification method for this kind of capacitor. However it is a time consuming and laboring process.

Second, since the thickness of the copper foil or the circuit board in the wash processing for capacitance preparation is not uniform, the equivalent capacitance for the pad will be different. Therefore, it needs to adjust the equivalent capacitance first while applying the conventional identification method for this kind of equivalent capacitance. However it is also a time consuming and laboring process. In conclusion, even few variations are existed between the capacitors or the equivalent capacitance, it is still difficult to identify whether the key is in a touch or in a no-touch condition.

Based on the mentioned points, it is necessary for the manufacturers to develop an improved identification method without losing the sensitivity and the sensing capability (area) of a touch control device with a large amount of keys/pad positions. An improved identification method for overcoming the drawbacks of the conventional ones is provided in the present application accordingly.

### SUMMARY OF THE INVENTION

In accordance with an aspect of the present invention, an identification method for a touch control device is provided, wherein the touch control device having a memory and a pad electrically connected to an equivalent capacitance. The identification method for a touch control device includes steps of: (a) charging the equivalent capacitance for obtaining a first voltage value; (b) storing the first voltage value in the memory; (c) touching the pad; (d) scanning the pad for obtaining a second voltage value of the equivalent capacitance; and (e) comparing the first voltage value with the second voltage value of the equivalent capacitance for identifying a touched position on the pad.

Preferably, the touch control device further includes an integrator and the step (a) further includes steps of: (a1) providing a first pulse as a first energy to the equivalent capacitance; (a2) storing the first energy in the integrator; (a3) amplifying and converting a first output of the integrator to a first digital signal; and (a4) multiplying the first digital signal by a numeral for obtaining the first voltage value.

Preferably, the step (b) further includes steps of: (b1) eliminating the first energy stored in the integrator.

Preferably, a user sets the number for flexibly changing an identification sensitivity of the touch control device.

Preferably, the memory and the integrator are incorporated in a micro controlled unit (MCU).

Preferably, the step (c) further includes steps of: (c1) providing a second pulse as a second energy to the equivalent capacitance; (c2) storing the second energy in the integrator; and (c3) amplifying and converting a second output of the integrator to a second digital signal for obtaining the second voltage value.

Preferably, the touch control device further comprises a micro controlled unit (MCU) for controlling each of the steps.

Preferably, the memory is a random access memory (RAM).

In accordance with another aspect of the present invention, an identification method for a touch control device is provided, wherein the touch control device having a memory and plural keys and each key is electrically connected to a capacitor. The identification method for a touch control device includes steps of: (a) charging each capacitor for obtaining a respective first voltage value; (b) storing the respective first voltage value in the memory; (c) touching at least one of the keys; (d) scanning each key for obtaining a respective second voltage value of the capacitor; and (e) comparing the first voltage value with the second voltage valve of each capacitor for identifying whether each key is touched.

Preferably, the touch control device further includes an integrator and the step (a) further comprises steps of: (a1) providing a first pulse as a first energy to each capacitor; (a2) storing each first energy in the integrator; (a3) amplifying and converting a first output of the integrator to a first digital signal; and (a4) multiplying the first digital signal by a numeral for obtaining the respective first voltage level.

Preferably, the step (b) further includes: (b1) eliminating the first energy stored in the integrator.

Preferably, a user sets the numeral for flexibly changing an identification sensitivity of the touch control device.

Preferably, the memory and the integrator are incorporated in a micro controlled unit (MCU).

Preferably, the step (c) further includes steps of: (c1) providing a second pulse as a second energy to each capacitor; (c2) storing the second energy in the integrator; and (c3) amplifying and converting a second output of the integrator to a second digital signal for gaining the second voltage value.

Preferably, the touch control device further includes a micro controlled unit (MCU) for controlling each of the steps.

Preferably, the memory is a random access memory (RAM).

The above contents and the advantages of the present invention will become more readily apparent to those ordinarily skilled in the art after reviewing the following detailed descriptions and accompanying drawings, in which:

### BRIEF DESCRIPTION OF THE DRAWINGS

FIG. 1 (a) is a diagram showing the flow chart illustrating steps of the storing stage of the identification method for a touch control device according to a preferred embodiment of the present invention;

FIG. 1 (b) is a diagram showing the flow chart illustrating steps of the scanning and comparing stage of the identification method for a touch control device according to a preferred embodiment of the present invention;

FIGS. 1 (c) and 1(d) are diagrams showing the pulse waveforms obtained by means of the identification method illustrated in FIGS. 1(a) and 1 (c), respectively;

FIG. 2 (a) is a diagram showing the structure of a capacitive touch control device for the identification method according to a first preferred embodiment of the present invention;

FIG. 2 (b) is a diagram showing the structure of a capacitive touch control device for the identification method according to a second preferred embodiment of the present invention;

FIG. 3 is a diagram showing different types of the capacitive elements for the capacitive control device shown in FIG. 2(a);

FIGS. 4 (a) and 4(b) are diagrams showing the circuits of the capacitive elements as well as the pulse waveforms of the input and the output signals of the capacitive control device shown in FIGS. 2 (a) and 2(b) respectively;

FIGS. 5(a) and 5(b) are diagrams showing circuits of the integrators as well as the pulse waveforms of the input and the output signals of the capacitive control device shown in FIGS. 2 (a) and 2(b) respectively;

FIG. 6 is a diagram showing the circuit of the operational amplifier shown in FIG. 2(a) or 2(b) and the pulse waveforms of the input and the output signals thereof; and

FIG. 7 is a diagram showing the input and the output signals of the analog/digital converting circuit shown in FIGS. 2 (a) or 2(b).

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

The principle of the present invention is described below. Firstly, the electric potential charged by each key/pad position is stored as its own reference potential, which could be presented as a reference voltage value for the later comparing step. Secondly, when the user touches the key/pad position, the electric potential energy is absorbed by the user's finger and hence the voltage value of the touched key/pad position is lower than the respective reference voltage value, whereby the micro controlled unit in the touch control device would identify the touched key/pad position according thereto.

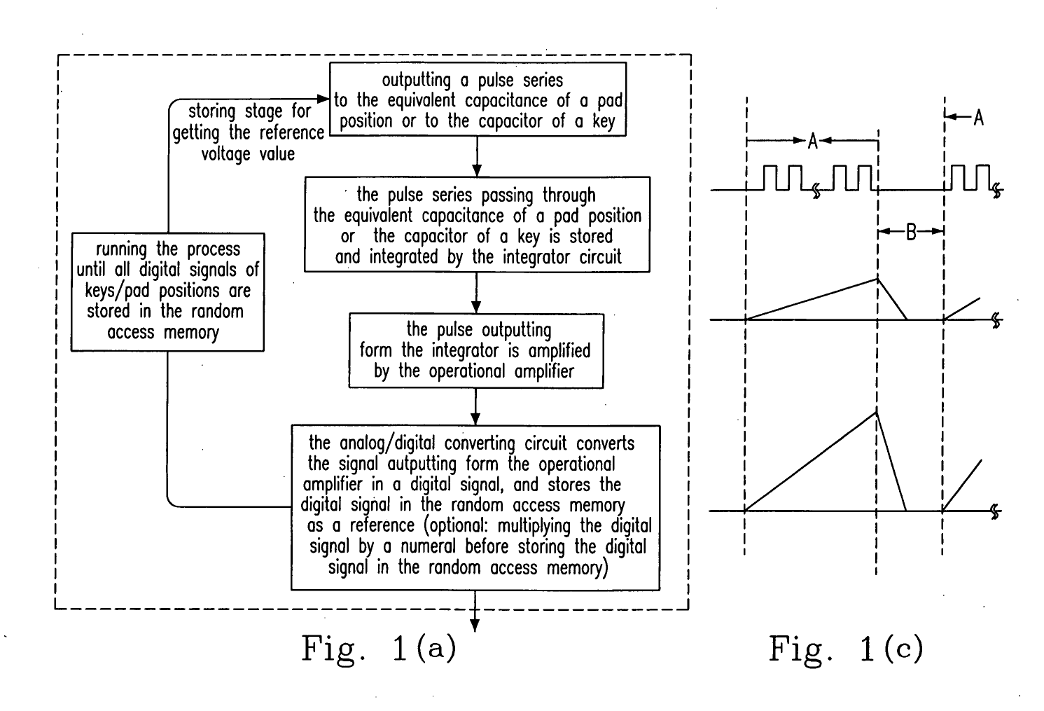

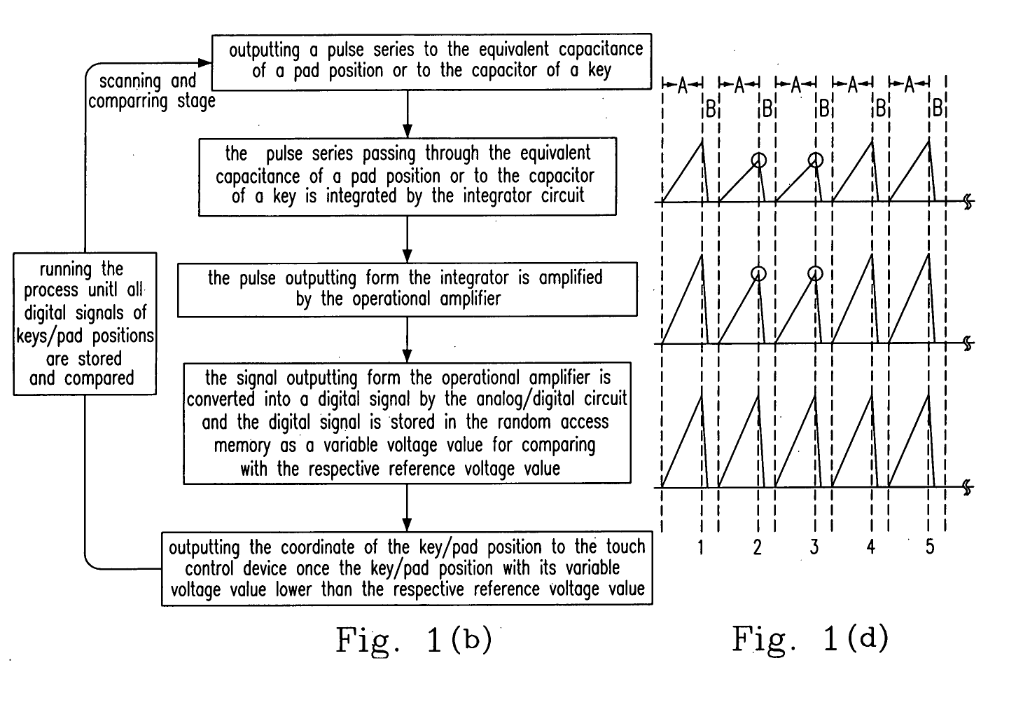

Please refer to FIGS. 1 (a)-(d), wherein FIG. 1 (a) is a flow chart illustrating steps of the storing stage of the identification method for a touch control device according to a preferred embodiment of the present invention, FIG. 1 (b) is a flow chart illustrating steps of the scanning and comparing stage of the identification method for a touch control device according to a preferred embodiment of the present invention, and FIGS. 1 (c) and 1(d) are diagrams showing the pulse waveforms obtained by means of the identification method illustrated in FIGS. 1(a) and 1 (c), respectively. The operation of the touch control device controlled by the micro control unit are divided into two stages including the storing stage for getting the reference voltage value as shown in FIG. 1(a), and the scanning and comparing stage as shown in FIG. 1(b).

As shown in FIGS. 1(a) and 1(c), the storing stage for getting the reference voltage value includes the following steps:

(a1) The micro control unit outputs a first pulse series from the output terminal thereof to the equivalent capacitance of a pad or to the capacitors of the keys for charging the equivalent capacitance of a pad or for charging the capacitors of the keys with a first energy, i.e. an electric potential. The pulse waveform of the pulse series during a charging period A and a discharging period B are shown in the top part of FIG. 1(c), wherein the pulse series is output to the equivalent capacitance of pad or to the capacitors of keys only during the charging period A.

(a2) The integrator stores and integrates the respective first energy of each equivalent capacitance of pad positions or each capacitor of keys after each equivalent capacitance of the pad positions or the capacitor of keys receives the first pulse series. The pulse waveform of the integrated pulse of the key/pad position during the charging period A and the discharging period B is shown in the middle part of FIG. 1(c).

(a3) The operational amplifier amplifies each integrated pulse from the integrator. The pulse waveform of the amplified output signal during the charging period A and the discharging period B is shown in the bottom part of FIG. 1(c).

(a4) The analog/digital converting circuit converts each signal outputting from the operational amplifier into a respective first digital signal, and then the respective first voltage value of each keys/pad positions is obtained by multiplying each first digital signal by a numeral, e.g. a specific ratio, wherein each first voltage value of keys/pad positions is stored in the memory as the reference voltage value for the following steps for identification. Usually the specific ratio is 95% or 90%, which is used for flexibly controlling the sensitivity of the identification method for the touch control device. The sensitivity of the touch control device would decrease while the specific ratio is small, or on the contrary, the touch control device would be more sensitive and risk in the misinterpretation while the specific ratio is large. Therefore, the specific ratio for controlling the sensitivity of the touch control device is set flexibly for complying with the need of the device or personal preference.

(a5) The potential stored in the integrator is eliminated.

After each reference voltage value is obtained, it is ready for the micro control unit to operate in the following scanning and comparing stage. As shown in FIGS. 1 (b) and 1(d), the scanning and comparing stage includes the following steps:

(b1) The micro control unit outputs a second pulse series from the output terminal thereof to the equivalent capacitance of pad positions or to the capacitors of keys for charging the equivalent capacitance of a pad or for charging the capacitors of the keys with a second energy, i.e. an electrical potential.

(b2) The integrator stores and integrates the respective second energy of each equivalent capacitance of pad positions or each capacitor of keys after the equivalent capacitance of the pad or the capacitor of keys receives the second pulse series. The pulse waveform of the stored pulse series for the keys/pad position (keys/pad positions 1-5) during the charging period A and the discharging period B are shown in the top part of FIG. 1 (d)

(b3) The operational amplifier amplifies each integrated pulse from the integrator. The pulse waveforms of the amplified output signals for the keys/pad positions (keys/pad positions 1-5) during the charging period A and the discharging period B are shown in the middle part of FIG. 1(d). In comparison with the above-mentioned reference pulse waveforms of the amplified output signals for the keys/pad positions shown in the bottom part of FIG. 1(d), it is apparent that keys/pad positions 2-3 have the lower spike amplitudes, and hence are identified as being in a touch condition.

(b4) The analog/digital converting circuit converts each signal from the operational amplifier into a respective second digital signal so that the micro control unit scans the keys/pad positions and stores each second digital signal as a respective second voltage value of the keys/pad position in the memory for comparing with the respective reference voltage value.

(b5) The scanning and comparing stage is done in a sequence, once a key/pad position with its second voltage value lower than the respective reference voltage value is identified. The micro control unit would output the coordinate of the identified key/pad position to the touch control device. Otherwise the micro control unit would keep on the scanning and comparing stage for the next key/pad position.

It should be noted that the memory for storing the voltage value of each key/pad position could be a random-access memory (RAM). Consequently, while the touch control device is restarted due to the power cut0off or reset, the micro control unit would recalculate and restore each first potential/voltage value as a respective reference.

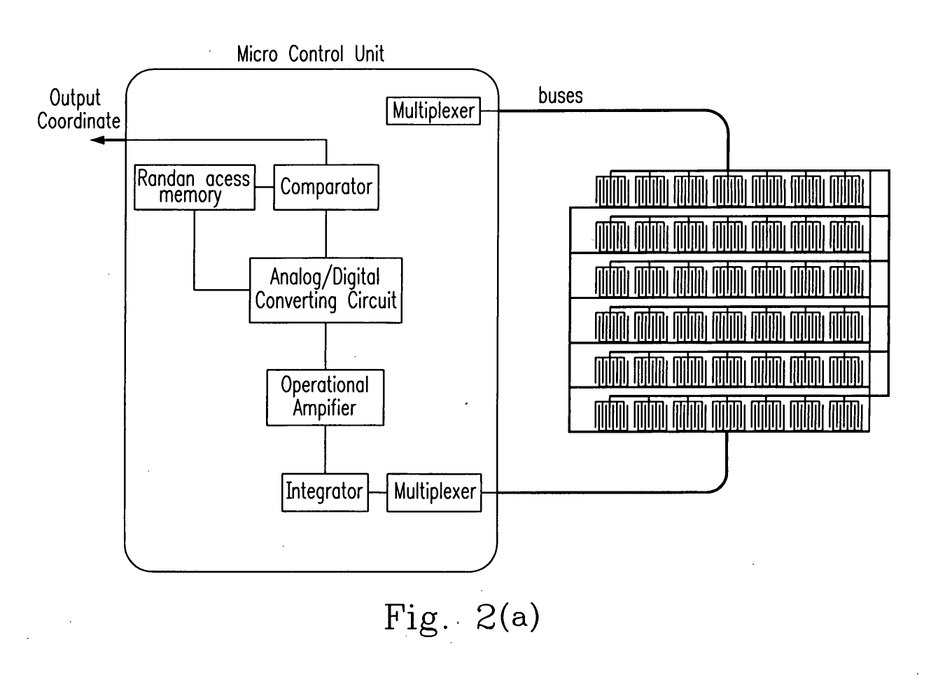

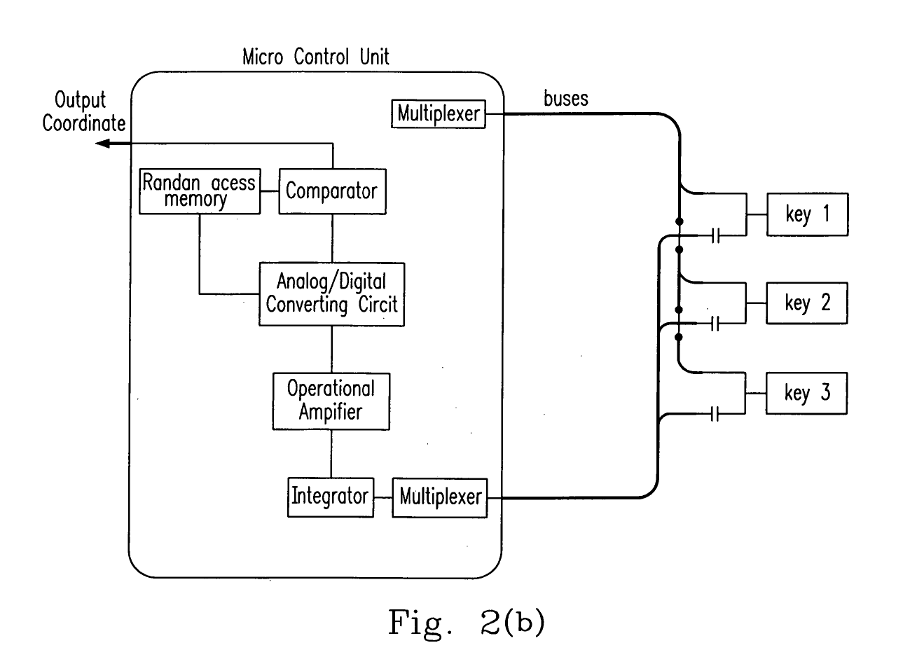

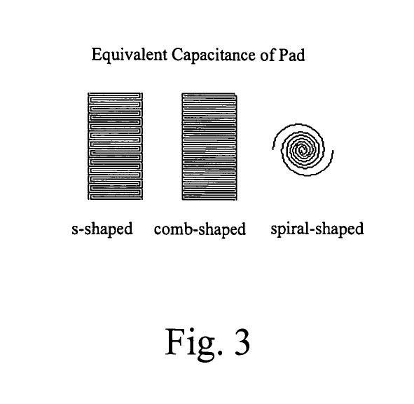

The identification method for a capacitive touch control device of the present invention could be applied for the capacitive touch control device shown in FIGS. 2 (a) or 2(b). As shown in FIG. 2(a), the capacitive elements are configured on the circuit board of the pad for forming plural equivalent capacitances thereon. As shown in FIG. 2(b), a capacitor is directly arranged on each key for the charge coupling. It should be noted that the configuration of the equivalent capacitance shown in FIG. 2(a) could be variable, and other configurations such as an s-shaped, a comb-shaped and a spiral-shaped equivalent capacitances shown in FIG. 3 are also applicable without affecting the sensitivity of the identification method for a capacitive touch control device of the present invention.

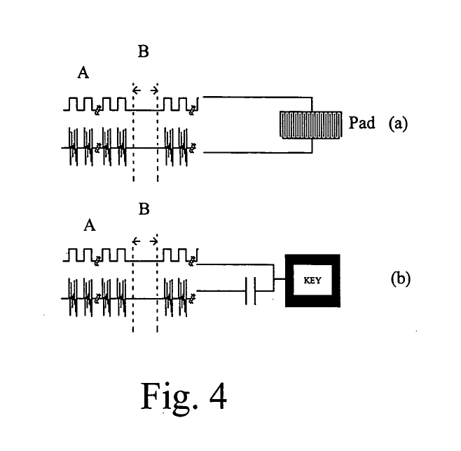

Please refer to FIGS. 4-7, which are diagrams showing the circuits of the electric elements as well as the pulse waveforms of the input and the output signals of the capacitive control device shown in FIGS. 2 (a) and 2(b).

As shown in FIGS. 4 (a) and 4(b), which are diagrams showing the circuits of the capacitive elements as well as the pulse waveforms of the input and the output signals of the capacitive control device shown in FIGS. 2 (a) and 2(b), respectively. While the capacitive touch control device is activated, in the mentioned step (a1) of the storing stage or in the step (b1) of scanning and comparing stage, the capacitive element of the key and the pad are charged by means of generating the output signals in responding to the input pulse series, i.e. a potential energy.

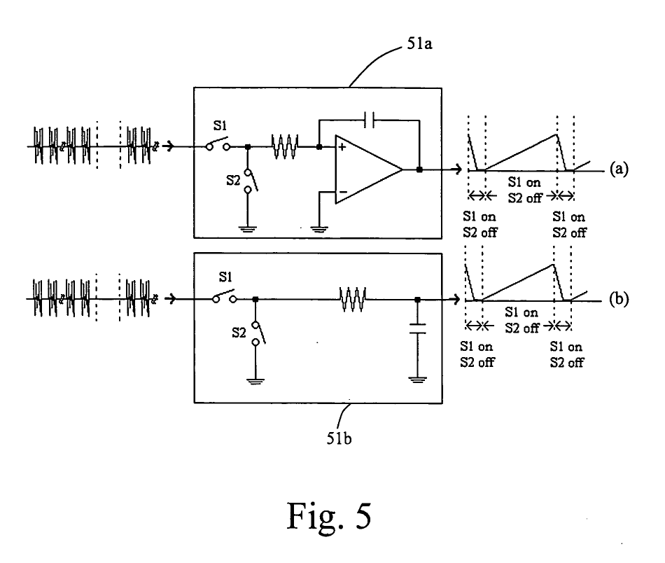

Furthermore, please refer to FIGS. 5(a) and 5(b), which are diagrams showing circuits of the integrators as well as the pulse waveforms of the input and the output signals of the capacitive control device shown in FIGS. 2 (a) and 2(b), respectively. The responding output signals from the pad or the key are input into to the integrator 51a or 51b, and are stored and integrated thereby. The stored and integrated signals are subsequently transmitted to the operational amplifier.

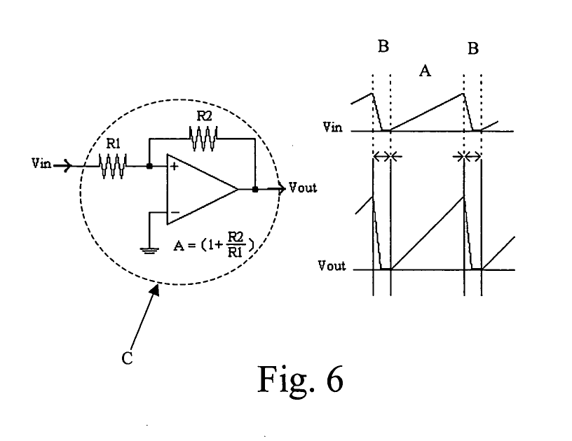

In addition, please further refer to FIG. 6, which is a diagram showing the circuit of the operational amplifier shown in FIG. 2(a) or 2(b) and the pulse waveforms of the input and the output signals thereof. Since the amplitude of the saw-shaped output signals shown in FIGS. 5(a) and 5(b) are too small, an amplification in hence necessary. The saw-shaped signal Vin outputting from the integrator is amplified by the circuit of an operational amplifier C to a relatively high saw-shaped output signal Vout. The respective pulse waveforms of signals Vin and Vout of FIG. 6 show that the spike amplitude of the Vout signal is bigger than the spike amplitude of the Vin signal.

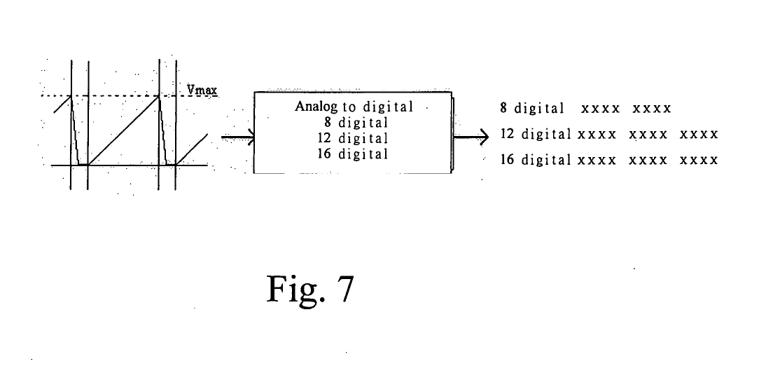

At last, as shown in FIG. 7, which is a diagram showing the input and the output signals of the analog/digital converting circuit shown in FIGS. 2 (a) or 2(b), the amplified signal is converted to a digital signal by an analog to digital converting device.

If the digital signal is obtained in the storing stage for getting the reference voltage value, the respective first voltage value of each keys/pad positions would be obtained by multiplying each digital signal by a numeral, otherwise, if the digital signal is obtained in the scanning and comparing stage, the digital signal itself is read as a variable voltage value after being touched. The identification of whether the key/pad position is touch could be done by comparing these two voltage values (the reference voltage value and the variable voltage value), and whenever the key/pad position with its variable voltage value lower the respective reference one, the coordination thereof would be sent out by the input/output terminal of micro control unit for showing the key/pad position is in a touch condition.

In the above-described embodiments, the memory and the integrator are configured individually for accomplishing the identification of the capacitive touch control device. It should be noted that, in practical, those two elements could be integrated into the micro control unit.

In view of the foresaid discussions, the present invention does provide an identification method for a capacitive touch control device so that the identification of the capacitive touch control device is more sensitive and the sensing area thereof is broader. In addition, the method also provides more flexibility for the design of the keys/pad position of the capacitive touch control device. Since the identification method for a capacitive touch control device according to the present invention does solve the faults of the prior arts, the present invention does have the novelties, progressiveness, and utilities.

While the invention has been described in terms of what is presently considered to be the most practical and embodiment, it is to be understood that the invention needs not be limited to the disclosed embodiments. On the contrary, it is intended to cover various modifications and similar arrangements included within the spirit and scope of the appended claims that are to be accorded with the broadest interpretation so as to encompass all such modifications and similar structures.

What is claimed is:

1. An identification method for a touch control device having a memory and a pad electrically connected to an equivalent capacitance, comprising:
(a) charging said equivalent capacitance for obtaining a first voltage value;
(b) storing said first voltage value in said memory;
(c) touching said pad;
(d) scanning said pad for obtaining a second voltage value of said equivalent capacitance; and
(e) comparing said first voltage value with said second voltage value of said equivalent capacitance for identifying a touched position on said pad.

2. The identification method as claimed in claim 1; wherein said touch control device further comprises an integrator and said step (a) further comprises:
(a1) providing a first pulse as a first energy to said equivalent capacitance;
(a2) storing said first energy in said integrator;
(a3) amplifying and converting a first output of said integrator to a first digital signal; and
(a4) multiplying said first digital signal by a numeral for obtaining said first voltage value.

3. The identification method as claimed in claim 2, wherein said step (b) further comprises:
(b1) eliminating said first energy stored in said integrator.

4. The identification method as claimed in claim 2, wherein said number is set by a user for flexibly changing an identification sensitivity of said touch control device.

5. The identification method as claimed in claim 2, wherein said memory and said integrator are incorporated in a micro controlled unit (MCU).

6. The identification method as claimed in claim 1, wherein said step (c) further comprises steps of:
(c1) providing a second pulse as a second energy to said equivalent capacitance;
(c2) storing said second energy in said integrator; and
(c3) amplifying and converting a second output of said integrator to a second digital signal for obtaining said second voltage value.

7. The identification method as claimed in claim 1, wherein said touch control device further comprises a micro controlled unit (MCU) for controlling each of said steps.

8. The identification method as claimed in claim 1, wherein said memory is a random access memory (RAM).

9. An identification method for a touch control device having a memory and plural keys and each said key is electrically connected to a capacitor, comprising:
(a) charging each said capacitor for obtaining a respective first voltage value;
(b) storing said respective first voltage value in said memory;
(c) touching at least one of said keys;
(d) scanning each said key for obtaining a respective second voltage value of said capacitor; and
(e) comparing said first voltage value with said second voltage valve of each said capacitor for identifying whether each said key is touched.

10. The identification method as claimed in claim 9, wherein said touch control device further comprises an integrator and said step (a) further comprises:
(a1) providing a first pulse as a first energy to each said capacitor;
(a2) storing each said first energy in said integrator;
(a3) amplifying and converting a first output of said integrator to a first digital signal; and
(a4) multiplying said first digital signal by a numeral for obtaining said respective first voltage level.

11. The identification method as claimed in claim 10, wherein said step (b) further comprises:
(b1) eliminating said first energy stored in said integrator.

12. The identification method as claimed in claim 10, wherein said numeral is set by a user for flexibly changing an identification sensitivity of said touch control device.

13. The identification method as claimed in claim 10, wherein said memory and said integrator are incorporated in a micro controlled unit (MCU).

14. The identification method as claimed in claim 9, wherein said step (c) further comprises steps of:
(c1) providing a second pulse as a second energy to each said capacitor;
(c2) storing said second energy in said integrator; and
(c3) amplifying and converting a second output of said integrator to a second digital signal for gaining said second voltage value.

15. The identification method as claimed in claim 9, wherein said touch control device further comprises a micro controlled unit (MCU) for controlling each of said steps.

16. The identification method as claimed in claim 9, wherein said memory is a random access memory (RAM).
